(19) United States
(12) Patent Application Publication
(10) Pub. No.: US 2007/0085981 A1
(43) Pub. Date: Apr. 19, 2007

(54) Assemblies and methods for displaying an image

(76) Inventors: Anders Malthe, Bjarred (SE); Nils Risberg, Oxie (SE); Per Anders Holmberg, Lund (SE); Per Wahlstrom, Malmo (SE)

Correspondence Address: MYERS BIGEL SIBLEY & SAJOVEC, P.A., P.O. BOX 37428, RALEIGH, NC, 27627, US

(21) Appl. No.: 11/250,882

(22) Filed: Oct. 14, 2005

(51) Int. Cl. G03B 21/14

(52) U.S. Cl. 353/119

(57) ABSTRACT

An assembly and a method for displaying at least one image in an electronic device. The assembly comprises a projector unit, which includes at least one light emitter and an image forming element, and a plane of projection. The light emitter is configured to emit light towards the image forming element. The image forming element is configured to form at least one image by utilizing light emitted by the light emitter. The projector unit is configured to project an image formed by the image forming element on the plane of projection.

### FIELD OF THE INVENTION

The present invention relates to an assemblies and methods for displaying at least one image.

### BACKGROUND

An electronic apparatus may include a user interface, through which a user may interact with the apparatus. The user interface may include one or more input devices, such as one or more keys, joysticks, or rocker pads and the like.

A portable or handheld apparatus, such as a mobile terminal, may provide various functionalities, such as communication, games, and multi-media rendering. For each functionality, the portable apparatus may be put in a corresponding operational mode, such as a communication mode, a game mode, and/or a multi-media mode. In each mode, the user may operate the apparatus by interacting with the user interface.

A portable apparatus may include several operational modes. To decrease the number of input devices used, each input device may be used in connection with different functionalities depending on the operational mode. For example, in the communication mode, a single key may be used for entering a “1”, whereas the same key in the multi-media mode may be used for initiating a “play” command for rendering multi-media data.

For ease of operation of a portable apparatus, symbols may be provided in connection with a corresponding input device. The symbol relating to the functionality may be integrally formed with or formed at the input device. If each input device is associated with several functionalities, several symbols may need to be provided in connection with each input device. This may be a problem as the physical area available in a portable communication apparatus for each input device is limited. As a result, the symbols may be relatively small and difficult to read. Furthermore, it may be difficult to distinguish the symbols from each other and/or be confusing for the user because the current functionality of the input device may be unclear.

Symbols may also be provided at other surfaces of an electronic apparatus.

### SUMMARY OF THE INVENTION

According to some embodiments of the invention, an assembly for displaying at least one image in an electronic device includes a projector unit, which includes at least one light emitter and an image forming element, and a plane of projection. The light emitter is configured to emit light towards the image forming element. The image forming element is configured to form at least one image by utilizing light emitted by the light emitter. The projector unit is configured to project an image formed by the image forming element on the plane of projection.

The projector unit may include a lens, which is configured to focus the image formed by the image forming element on the plane of projection.

The plane of projection may include a translucent surface.

The light emitter may be provided within the housing of the electronic device, and be directed towards the exterior of the housing.

The projector unit may include a reflector configured to direct light emitted by the light emitter towards the plane of projection. The reflector may include at least one mirror. Furthermore, the reflector may include a plurality of controllable mirrors. The controllable mirrors may provide the image forming element. Alternatively, the reflector includes a prism.

The image forming element may include a pattern, which forms the image.

The image forming element may include a display unit for forming the pattern.

The plane of projection may be included in a surface of the electronic device, which is visible from the exterior of the electronic device.

According to some embodiments of the invention, an electronic device includes the assembly for displaying at least one image.

The electronic device may be a portable or handheld mobile radio communication equipment, a mobile radio terminal, a mobile telephone, a pager, a communicator, an electronic organizer, a smartphone, a media player, an audio player, an MP3 player, a camera, a GPS unit, a game console, a game unit, or a computer.

According to some embodiments of the invention, a method for displaying at least one image in an electronic device includes controlling at least one light emitter to emit light towards an image forming element, forming at least one image by utilizing light emitted by the light emitter, and projecting the image formed by the image forming element on a plane of projection.

A lens may be used to focus the image on the plane of projection.

The method may include directing light emitted by the light emitter towards a translucent surface, which forms the plane of projection.

The method may include directing light emitted by light emitter towards a reflector configured to direct light emitted by the light emitter towards the plane of projection.

The method may include controlling a plurality of mirrors, which provide the image forming element, to form the image.

While the invention has been described above primarily with respect to the methods and imaging assembly aspects of the invention, both systems and/or computer program products are also provided.

### BRIEF DESCRIPTION OF THE DRAWINGS

Further features and advantages of embodiments according to the invention will appear from the following detailed description of the invention, reference being made to the accompanying drawings, in which:

FIG. 1 is a front-view of an electronic device in which an assembly for displaying at least one image may be included according to embodiments of the present invention;

FIGS. 2-6, 8-9, and 11 are schematic views of assemblies for displaying at least one image according to embodiments of the present invention;

FIG. 7 is a top view of an assembly for displaying at least one image according to embodiments of the present invention;

FIG. 10 is a block diagram of an array of mirrors according to embodiments of the present invention;

FIG. 12 is a block diagram of components of the electronic device according to embodiments of the present invention; and

FIG. 13 is a flow chart illustrating operations for displaying at least one image in the electronic device according to embodiments of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention are described by way of example with reference to the figures. According to some embodiments of the invention, a light emitter and an image forming element form a projector unit for projecting an image on a plane of projection. The image formed by the image forming element may be projected on the plane of projection when the light emitter is in operation. In embodiments of the invention, the plane of projection forms a projection screen.

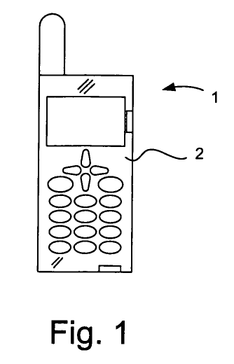

FIG. 1 illustrates an electronic device 1, in which the assembly may be provided. The assembly may be included within the electronic device 1, such as within a housing 2 of the electronic device 1. At least one image may e.g. be projected on a single physical area. In various embodiments, multiple images may be projected within the same physical area. The electronic device 1 may e.g. be an a portable or handheld mobile radio communication equipment, a mobile radio terminal, a mobile telephone, a pager, a communicator, an electronic organizer, a smartphone, a media player, an audio player, e.g. an MP3 player, a camera, a GPS (Global Positioning System) unit, a game console, a game unit, a computer or the like.

The image may e.g. be provided within a single physical area, such as an image on or within a key, a button, a joystick, or a portion of a surface of the housing 2 of the electronic device 1.

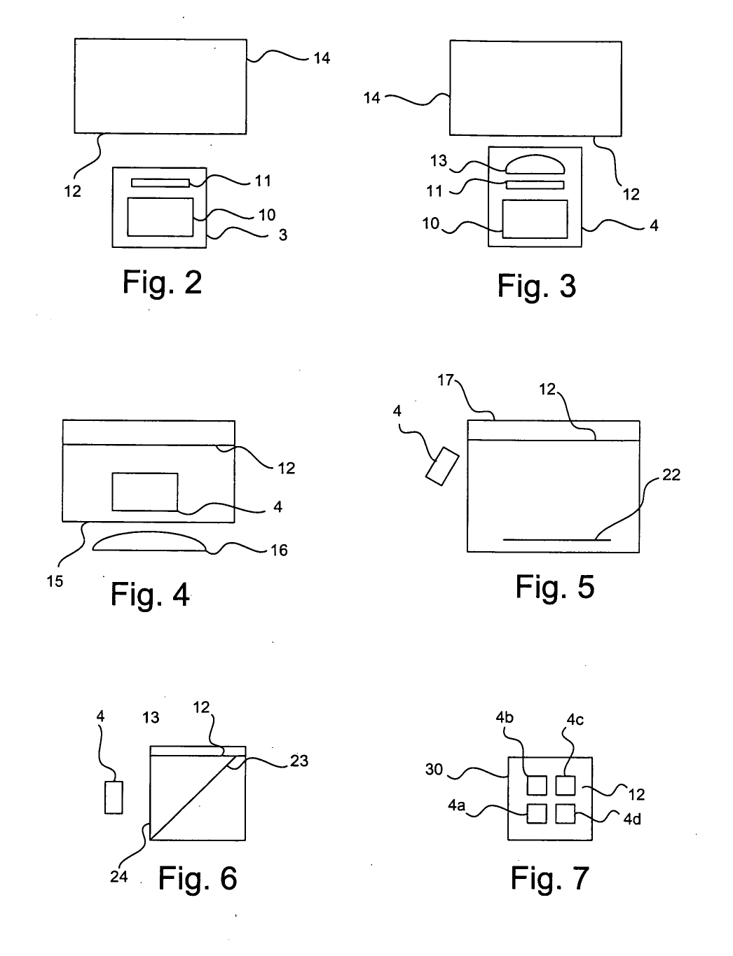

FIG. 2 illustrates an assembly for displaying at least one image in the electronic device 1. The assembly includes a projector unit 3. The projector unit 3 includes a light emitter 10, and an image forming element 11. The light emitter 10 is configured to emit light towards the image forming element 11. The image forming element 11 is configured to form at least one image by utilizing the light emitted by the light emitter. The projector unit 3 is configured to project the image formed by the image forming element 11 on a plane of projection 12. The light emitter 10 as shown in FIG. 2 is directed towards the plane of projection 12. Also, the image forming element 11 is provided between the light emitter 10 and the plane of projection 12. Thus, when the light emitter 10 is in operation, the image formed by the image forming element 11 will be projected on the plane of projection 12. The plane of projection may be provided at a surface of a member 14.

FIG. 3 illustrates further embodiments of the assembly for forming at least one image in the electronic device 1. The assembly of FIG. 3 includes a projection unit 4, which includes a lens 13 in addition to the light emitter 10 and the image forming element 11. The lens 13 shown in FIG. 3 is provided between the image forming element 11 and the plane of projection 12. The lens 13 is adapted to focus the image on the plane of projection 12. The lens 13 may also be adapted to spread the light from the light emitter 10. Thus, the size of the image may be increased. The focal distance between the lens 13 and the plane of projection 12 is set to provide sharpness of the image on the plane of projection 12.

In the embodiments of FIGS. 2 and 3, the light emitter 10, the image forming element 11 and the lens 13, if it is provided, are provided separated from the plane of projection and from member 14.

FIG. 4 illustrates other embodiments, wherein the projection unit 4 and the plane of projection 12 are provided within a member 15. Member 15 may e.g. be a displaceable key or button. The position of the lens 13 is fixed in relation to the position of the plane of projection 12. Thus, the focal distance between the lens 13 and the plane of projection 12 is fixed when the key or button is in a rest position as well as in a displaced position. This configuration has the advantage that the focus of the image may be constant. Furthermore, the space available for positioning the light emitter 11 may be limited. If member 15 is a key, the key may be provided opposite a dome 16 of a dome switch. Thus, the space available may not be sufficient to position the projection unit 4 beside the dome 16. The configuration of FIG. 4 reduces this problem. However, in other embodiments, the projector unit 4 may be positioned beside the dome 16 and be directed towards the plane of projection.

FIG. 5 illustrates further embodiments of the assembly. In the embodiments of FIG. 5, the plane of projection is provided within member 17. Furthermore, in the embodiments of FIG. 5, the projector unit 4 includes a reflector 22. The reflector 22 is configured to direct light emitted by the light emitter 10 towards the plane of projection 12. The light emitter 10 is directed towards the reflector 22. The reflector 22 may be provided within member 17. However, in some embodiments, the reflector 22 may be separated from member 17, e.g. opposite member 17. Reflector 22 may e.g. be a mirror or a prism.

In the embodiments of FIG. 6, the reflector 23 is a substantially flat surface. The flat surface is directed substantially 45 degrees relative the direction, from which the image will be viewed. However, other directions are possible depending on the position of the light emitter 10. The reflector 23 is provided within member 24. However, the reflector could be provided separated from member 24.

The reflector 22 according to the embodiments of FIG. 5 may be an arched mirror. The reflector 23 according to the embodiments of FIG. 6 may be a flat mirror. The projector unit 4 is positioned such that light emitted by its light emitter 10 will be directed by the reflector 22, 23 towards the plane of projection 12.

FIG. 7 illustrates a top view of an assembly for displaying a plurality of images. The images are displayable within a single physical area 30. The physical area 30 may be the member 14, 15, 17, 24. The assembly includes four projector units 4a, 4b, 4c, 4d. The plane of projection 12 is shown as transparent for illustrative purposes. Each projector unit 4a-4d is provided to generate a separate image. The emitters of each unit 4a-4d may be controlled to emit light one at the time. Thus, different images may be provided within the same physical area 30. This is e.g. useful if a single key or button is used for different purposes depending on the operational mode of the electronic device in which they are provided. For example, a first image, e.g. a numeral, is displayed when the electronic device 1 is in a communicational mode. Thus, the key is used to input the numeral displayed. In another mode, a second image, such as a “play” symbol is displayed when the electronic device 1 is in another mode, such as a music mode. Then, the same key is used to initiate a “play” command. The assembly may also be provided to switch between e.g. an alpha-numeric keypad to a keypad for character input. Thus, several images may be displayed in connection with or within a single physical area. The projector units 4a-4d of FIG. 7 and the plane of projection 12 may be configured as the projector unit 3 or 4 and the plane of projection 12 according to any of the embodiments of FIGS. 2-4.

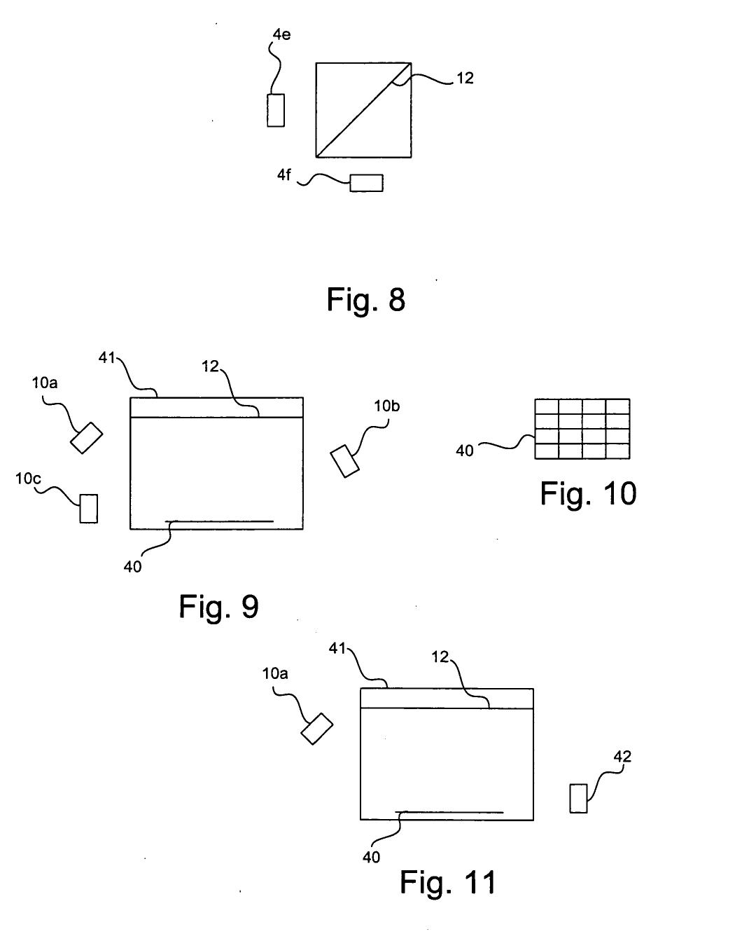

FIG. 8 illustrates embodiments according to the present invention which are similar to the embodiments of FIG. 6. The difference between the embodiments of FIG. 8 and the embodiments of FIG. 6 is that the plane of projection 12 of the embodiments of FIG. 8 includes a translucent surface. Thus, images may be projected on a first and a second side of the plane of projection 12. A first projector unit 4e is configured to project a first image on a first side of the plane of projection 12. If it is desired to project further images, a second projector unit 4f is configured to project a second image on the second side of the plane of projection 12. A third projector unit (not shown) may also be configured, e.g. opposite the first projector unit 4e, to project a third image on the second side of the plane of projection.

In other embodiments, groups of projector units, e.g. a group of four projector units, are positioned at the positions of the first and the second projector unit 4e, 4f of FIG. 8.

FIG. 9 illustrates embodiments according to the invention in which the projector unit includes at least one light emitter, 10a, 10b, 10c, and an image forming element, which is provided by a plurality of mirrors. Also, a plane of projection 12 is provided on which the projector unit projects the image when it is in operation. As illustrated, the image forming element is configured to utilize light emitted by the light emitters 10a, 10b, 10c to form at least one image. The plurality of mirrors may be micro mirrors.

FIG. 10 illustrates a top-view of an array of mirrors 40, which provides the plurality of mirrors in the embodiments of FIG. 9. The array of mirrors 40 includes 4×4 mirrors. However, the number of mirrors may be considerably larger and the number is only shown for illustrative purposes. The number of mirrors that is necessary depends on the resolution that is desired. The mirrors of the array of mirrors 40 are moveable in at least one direction. Also, the mirrors of the array of mirrors 40 are controllable. The mirrors of the array of mirrors can be directed towards the any of the light sources 10a-10c. Thus, the mirrors of the array of mirrors 40 may direct light from the light sources 10a-10c towards the plane of projection 12 when the mirrors are directed appropriately. Thus, light directed by a plurality of mirrors of the array of mirrors 40 together form the image on the plane of projection 12. The array of mirrors provides the image forming element in these embodiments.

In the embodiments of FIG. 9, a plurality of light sources 10-10c is shown. However, a single light source may together with the mirrors of the array of mirror provide several different images by controlling the mirrors of the array of mirrors 40 to form different images.

The mirrors of the array of mirrors 40 may be moved from a first position to at least a second position. In their first position, the mirrors of the array of mirrors 40 are directed away from the light emitters 10a-10c. Thus, light is prevented from being directed towards the plane of projection 12. In their second position, the mirrors of the array of mirrors 40 are directed towards any light emitter 10a- 10c. Thus, in their second position, light will be directed towards the plane of projection 12. The mirrors of the array of mirrors 40 may e.g. be rotatably moveable or directionally moveable. The mirrors of the array of mirrors may e.g. be moveable in 5 directions.

If it e.g. is required for the shape of the image to be formed, the mirrors of the array of mirrors 40 may have different shapes and/or sizes.

In the embodiments of FIG. 9, the array of mirrors is provided within member 41, in which the plane of projection 12 is provided. However, the array of mirrors 40 may be provided separated from member 41.

The light emitters 10a-10c may be light sources, such as LEDs or laser units. The light sources may be RGB LEDs. Thus, images may be provided in different colors. Alternatively, a plurality of single color LEDs, which have different colors, are provided to form a multi-color image and/or images having different colors. A single multi-color light source together with the array of mirrors 40 may provide images having different colors.

FIG. 11 illustrates embodiments according to the invention including an projector unit according to the principles of the embodiments of FIG. 9. In the embodiments of FIG. 11 the assembly also includes a light sensor 42. The light sensor is configured to detect light reflected by an object, which is located opposite the array of mirrors. The object may e.g. be a finger a fabric, a table surface, etc. When the object is sufficiently close to the member 41, light from the light emitter 10a is reflected by the object. The light reflected by the object is directed by a reflector towards the light sensor 42. The reflector may be at least one mirror of the array of mirrors 40.

The sensor may e.g. be light sensor, such as an IR (InfraRed) sensor. If the sensor is an IR sensor, one of the light emitters may be an IR light source.

The assembly of FIG. 11 may provide a switch. The switch may be used to provide a key for a keypad. The key may thus be a touch key. Thus, if member 41 is a key, it need not be moveable. The sensor may also be used to detect whether the electronic device 1, in which the assembly is located, is placed in e.g. a pocket. Then, any output device, such as a display, of the electronic device 1 could remain inoperative for as long as light is detected by the light sensor 42.

The array of mirrors 40 may e.g. be provided by a DLP™ (Digital Light Processing) unit.

The embodiments of FIGS. 4-8 have been described as including a projector unit 4, i.e. a projector unit including the lens 13. However, the projector unit 3 of FIG. 2 could alternatively be utilized in all embodiments.

An array of mirrors may e.g. be provided in connection with a single member, such as a key or button. Alternatively, a single array of mirrors is provided for a plurality of members, such as a plurality of keys of a keypad. The number of arrays of mirrors may depend on the size of each array and the size of the area, in which the images should be displayed.

Each image to be displayed in a single physical area may be generated using light having a different color. Thus, it may be easier to distinguish the current operational mode of the electronic device, if each mode is associated with a certain color. Also, it is possible to generate a color image within the single physical area, if the separate images are displayed at least partly simultaneously.

If a plurality of images should be generated with the assembly of FIG. 5, at least a second projector unit 4 may be positioned on other sides of member 17. Each projector unit 4 is directed towards the reflector 22. Alternatively, a plurality of projector units 4 may also be positioned together in a group if sufficient space is available. This is possible both in the embodiments of FIG. 5 and the embodiments of FIG. 6.

If several projector units are provided together, each light emitter may be connected to a light source, which is adapted to generate light having a different color. Thus, not only may different symbols be provided, but also symbols having different colors. Thus, it may be even easier to distinguish separate symbols alternatingly provided within the same physical area. Alternatively, a single projector unit is connected to a light source for generating light having different colors, such as an RGB (Red Green Blue) LED.

If several images are displayable, the images may be displayed in sequence within a single physical area. Thus, it is possible to provide an animated sequence, wherein the images together form a moving image.

The member 14, 15, 17, 24, 41 may e.g. be a key, a button, or a portion of the housing 2 of the electronic device 1.

In some embodiments, the image forming element 11 is a pattern or mask pattern. The pattern may be printed on a surface, e.g. a transparent piece of plastic. The pattern may e.g. be a screen printed pattern.

In some embodiments, the pattern forms the contours of the image. In other embodiments, the pattern forms the image, wherein the surroundings of the image on the surface is transparent/translucent. Thus, the emitted light is utilized by blocking light to form the image.

In some embodiments, such as in the embodiments of FIGS. 2-8, the image forming element is display unit. The display unit may e.g. be an LCD (Liquid Crystal Display) unit or TFT (Thin-Film Transistor) display unit. The display unit may be at least partly translucent. A single display unit may be used to form a multitude of different images using a single light emitter. The pattern is formed by the display unit. The emitted light is utilized by blocking light to form the image. Alternatively, light in different colors are emitted by the display unit.

The assembly may be provided within the housing 2 of the electronic device 1. In the embodiments of FIGS. 2-4 the light emitter 10 is directed outwardly from the interior of the housing 2 towards the exterior of the housing 2. In the embodiments of FIGS. 5-6, 9 and 11 the light emitter 10 is directed towards an interior of the housing 2.

The plane of projection may be provided at a surface of the member 14, 15, 17, 24, 41. In the embodiments of FIGS. 2 and 3, the surface is an exterior surface of member 14. In the embodiments of FIG. 4-6, 8-9 and 11, the plane of projection is an interior surface of a member 15, 17, 24, 41 in which it is provided.

In some embodiments, the member 14, 15, 17, 24, 41 is translucent. Then, the plane of projection may be an exterior surface of the member 14, 15, 17, 24, 41. In other embodiments, the member 14, 15, 17, 24, 41 is transparent. Thus, light generated by the light emitter 10 will pass through member 14, 15, 17, 24, 41. To prevent the user from looking directly into the light emitter 10, 10a-10c, the transparent member may include a translucent surface, which forms the plane of projection. The translucent surface may be an interior or exterior surface of the member 14, 15, 17, 24, 41. The plane of projection 12 may include the translucent surface. In the embodiments having the projector unit separated from the member 14, the plane of projection may be provided anywhere within or at a surface of the member 14.

In the embodiments of FIGS. 2-4, 8-9 and 11, the image is projected on a first side of the plane of projection 12. The image, when it is generated, will be viewed by a viewer from a second side on the plane of projection. In the embodiments of FIG. 8, the image may be projected on both sides of the plane of projection 12.

The image may e.g. include one or several letters, such as “A”, “B”, “OK”, etc. The image may also be one or several numerals, such as “1 ”, “2 ”, “37 ”, etc. The image may also for a symbol, such as a “play”, a “stop”, or a “rewind” symbol. The image may also be a character, such as a Chinese character. Furthermore, the image may be a picture, e.g. a trademark.

The light emitter 10, 10a-10c may include a light source. The light source may e.g. be a Light Emitting Diode (LED) or a laser source. The light source may form the light emitter 10, 10a-10c.

In other embodiments, the light emitter 10, 10a-10c is an opening of a light guide (not shown). The light guide is connected, at its end opposing an opened end, to a light source. The light source may e.g. be an LED or a laser source. For the keypad of the electronic device 1, one or several light sources may be provided for the entire keypad. Thus, a single light source may be connected to one or several light guides.

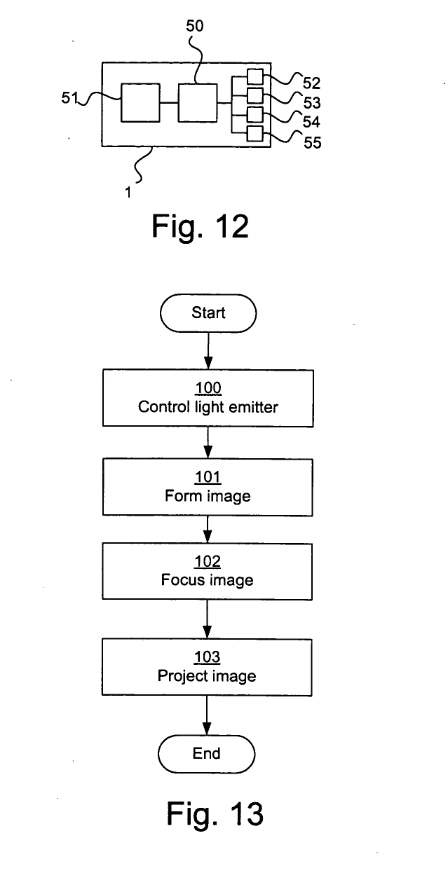

FIG. 12 illustrates some components of the electronic device 1, which includes the assembly. The electronic device 1 includes a controller 50. The controller 50 may e.g. be provided by a CPU (Central Processing Unit) running software for its functions, an ASIC (Application Specific Integrated Circuit), or an FPGA (Field Programmable Gate Array). The controller 50 may be connected to a memory 51, wherein software instructions for controlling projector units 52-55, such as their light emitters, light sources, and or controllable mirrors, may be stored. The controller is adapted to control any of the projector units 52-55,. The controller 50 is adapted to control the emission of light. Thus, the controller is adapted to control the generation of one or several images, e.g. as described above. In the embodiments of FIGS. 9 and 11, the controller 50 may be adapted to control movement of the mirrors of the array of mirrors 40.

FIG. 13 illustrates methods for displaying at least one image in the electronic device 1. In a first step 100, at least one light emitter is controlled to emit light towards the image forming element. In step 101, at least one image is formed by utilizing the light emitted by the light emitter. The image may be formed e.g. by passing the light through the image forming element or controlling movement of mirrors. In step 102, the image is focused, e.g. by means of the lens 13. In step 103, the light is directed towards the plane of projection. The light may e.g. be directed towards a translucent surface or a reflector as described above. Thus, the image is projected on the plane of projection.

All steps illustrated in FIG. 13 are not necessary in all embodiments of the invention. For example, the step of focusing is not necessary in all embodiments.

Embodiments according to the invention may at least partly be embedded in a computer program product, which enables implementation of the method and functions described herein. Embodiments according to the invention may be carried out when the computer program product is loaded and run in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

Methods according to the invention may also be implemented by hardware components, such as an ASIC, an FPGA, and or switches.

Accordingly, a plurality of images may be displayed in a single physical area. Furthermore, as the assembly is relatively small, it fits a relatively small electronic device, such as a handheld electronic device. Furthermore, if light having different colors is provided, multicolor images and/or images having different colors may be provided. Also, it may be possible to associate a single image with the operational mode of the electronic device in which it is displayed. Thus, the image may be associated with the current functionality, which e.g. a key is operative to control.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. For example, features of the embodiments illustrated in FIGS. 2-12 may be combined in other combinations then illustrated. The embodiments disclosed are only described by way of examples and may be combined in other combinations. Different method steps than those described above, performing the method by hardware or software, may be provided within the scope of the invention. The different features and steps of the invention may be combined in other combinations than those described. Accordingly, all such modifications are intended to be included within the scope of this invention as defined in the claims. The invention is defined by the following claims, with equivalents of the claims to be included therein.

We claim:

1. An assembly for displaying at least one image in an electronic device, comprising:
a projector unit including at least one light emitter and an image forming element; and
a plane of projection,
wherein the light emitter is configured to emit light towards the image forming element, the image forming element is configured to form at least one image by utilizing light emitted by the light emitter, and the projector unit is configured to project an image formed by the image forming element on the plane of projection.

2. The assembly according to claim 1, wherein the projector unit includes a lens configured to focus the image formed by the image forming element on the plane of projection.

3. The assembly according to claim 1, wherein the plane of projection comprises a translucent surface.

4. The assembly according to claim 1, wherein the light emitter is provided within the housing of the electronic device, and is directed towards the exterior of the housing.

5. The assembly according to claim 1, wherein the projector unit comprises a reflector configured to direct light emitted by the light emitter towards the plane of projection.

6. The assembly according to claim 5, wherein the reflector comprises at least one mirror.

7. The assembly according to claim 6, wherein reflector comprises a plurality of controllable mirrors.

8. The assembly according to claim 7, wherein the controllable mirrors provide the image forming element.

9. The assembly according to claim 5, wherein the reflector comprises a prism.

10. The assembly according to claim 1, wherein the image forming element comprises a pattern, which forms the image.

11. The assembly according to claim 10, wherein the image forming element comprises a display unit for forming the pattern.

12. The assembly according to claim 1, wherein the plane of projection is included in a surface of an electronic device and is visible from an exterior of the electronic device.

13. An electronic device comprising the assembly according to claims 1.

14. The electronic device according to claim 13, wherein the electronic device is a portable or handheld mobile radio communication equipment, a mobile radio terminal, a mobile telephone, a pager, a communicator, an electronic organizer, a smartphone, a media player, an audio player, an MP3 player, a camera, a GPS unit, a game console, a game unit, and/or a computer.

15. A method for displaying at least one image in an electronic device, the method comprising:
controlling at least one light emitter to emit light towards an image forming element;
forming at least one image by utilizing light emitted by the light emitter; and
projecting the image formed by the image forming element on a plane of projection.

16. The method according to claim 15, comprising focusing the image on the plane of projection by means of a lens.

17. The method according to claim 15, comprising directing light emitted by the light emitter towards a translucent surface, which forms the plane of projection.

18. The method according to claim 15, comprising directing light emitted by light emitter towards a reflector configured to direct light emitted by the light emitter towards the plane of projection.

19. The method according to claim 15, comprising controlling a plurality of mirrors, which provide the image forming element, to form the image.

20. A computer program product for displaying at least one image in an electronic device, the computer program product comprising:
a computer readable medium having computer readable program code embodied therein, the computer readable program code comprising:
computer readable program code configured to control at least one light emitter to emit light towards an image forming element;
computer readable program code configured to control the image forming element to form at least one image by utilizing light emitted by the light emitter such that a projection of the image is formed by the image forming element on a plane of projection.
